(19) United States
(12) Patent Application Publication
(10) Pub. No.: US 2020/0124414 A1
(43) Pub. Date: Apr. 23, 2020

(54) INFORMATION PROCESSING DEVICE, PROGRAM, AND WORK PROCESS GENERATION DEVICE

(71) Applicant: NIKON CORPORATION, Tokyo (JP)

(72) Inventors: Masaya YAMAGUCHI, Yokohama-shi (JP); Nobukatsu MACHII, Yokohama-shi (JP)

(73) Assignee: NIKON CORPORATION, Tokyo (JP)

(21) Appl. No.: 16/604,814

(22) PCT Filed: Apr. 13, 2017
(86) PCT No.: PCT/JP2017/015183

§ 371 Date: Oct. 11, 2019

(51) Int. Cl. G01B 21/16; G01B 21/08; F16H 57/021

(52) U.S. Cl. CPC G01B 21/16; F16H 57/021; G01B 21/08

(57) ABSTRACT

An information processing device that, assuming that a first member, provided with a first clearance adjustment target part and a first assembly part, and a second member, provided with a second clearance adjustment target part and a second assembly part, are assembled together by abutting the first assembly part and the second assembly part each other, calculates clearance information between the first clearance adjustment target part and the second clearance adjustment target part. The information processing device comprises a calculating unit configured to calculate the clearance information based on: first shape measurement data of the first assembly part; second shape measurement data of the second assembly part; first relative position information of the first clearance adjustment target part with respect to the first assembly part; and second relative position information of the second clearance adjustment target part with respect to the second assembly part.

### TECHNICAL FIELD

The present invention relates to an information processing device, a program, and a workflow generating device.

### BACKGROUND ART

Shapes of members have been measured and analyzed, and the obtained data has been used for an assembly of the members. In PTL 1, a shape of a vehicle body recognized by measurement from outside the vehicle body is compared with design data to analyze assembly accuracy of the vehicle body.

However, the method described in PTL 1 cannot obtain detailed data of a structure, such as a clearance between members, where measurement or adjustment from the outside is difficult after an assembly of the members.

### CITATION LIST

### Patent Literature

PTL 1: JP S64-13411 A

### SUMMARY OF INVENTION

According to a 1st aspect of the present invention, an information processing device that, assuming that a first member, provided with a first clearance adjustment target part and a first assembly part, and a second member, provided with a second clearance adjustment target part and a second assembly part, are assembled together by abutting the first assembly part and the second assembly part each other, calculates clearance information between the first clearance adjustment target part and the second clearance adjustment target part. The information processing device comprises a calculating unit configured to calculate the clearance information based on: first shape measurement data of the first assembly part; second shape measurement data of the second assembly part; first relative position information of the first clearance adjustment target part with respect to the first assembly part; and second relative position information of the second clearance adjustment target part with respect to the second assembly part.

According to a 2nd aspect of the present invention, in the information processing device according to the 1st aspect, it is preferable that the first clearance adjustment target part and the second clearance adjustment target part are surfaces opposite one another; and the clearance information is information including a degree distribution based on a plurality of distances between the first clearance adjustment target part and the second clearance adjustment target part.

According to a 3rd aspect of the present invention, in the information processing device according to the 2nd aspect, it is preferable that the plurality of distances are a plurality of values between a plurality of first elements of the first clearance adjustment target part and a plurality of second elements of the second clearance adjustment target part, corresponding to the first elements respectively.

According to a 4th aspect of the present invention, in the information processing device according to the 3rd aspect, it is preferable that the degree distribution is, with respect to the distances, a distribution of values based on a sum of areas of the first elements corresponding to the distances, or a distribution of values based on a sum of areas of the second elements corresponding to the distances.

According to a 5th aspect of the present invention, the information processing device according to any one of the 2nd to 4th aspects, it is preferable that the clearance information includes a first clearance amount calculated based on the degree distribution.

According to a 6th aspect of the present invention, in the information processing device according to the 5th aspect, it is preferable that the calculating unit is configured to generate a weighted degree distribution by: multiplying a first degree corresponding to a first distance among the plurality of distances by a first weighting coefficient; and multiplying a second degree corresponding to a second distance larger than the first distance among the plurality of distances by a second weighting coefficient smaller than the first weighting coefficient, and calculate the first clearance amount based on the generated weighted degree distribution.

According to a 7th aspect of the present invention, in the information processing device according to the 5th or 6th aspect, it is preferable that the calculating unit is configured to calculate a predetermined distance determined based on a local maximum value in the degree distribution as the first clearance amount, and with a presence of a plurality of local maximum values, calculate any of a plurality of predetermined distances determined based on the plurality of local maximum values as the first clearance amount.

According to an 8th aspect of the present invention, in the information processing device according to any one of the 2nd to 7th aspect, it is preferable to comprise: an optimal assembly position determining unit configured to determine an optimal assembly position between the first assembly part and the second assembly part.

According to a 9th aspect of the present invention, in the information processing device according to the 8th aspect, it is preferable that the optimal assembly position determining unit is configured to calculate the number of positions where a concave portion of one assembly part of the first assembly part and the second assembly part abuts on a convex portion of another assembly part of the first assembly part and the second assembly part while hypothetically changing assembly positions between the first member and the second member, and to determine the optimal assembly position based on the calculated number.

According to a 10th aspect of the present invention, in the information processing device according to the 8th aspect, it is preferable that the optimal assembly position determining unit is configured to determine the optimal assembly position such that a second clearance amount between the first assembly part and the second assembly part is minimized.

According to an 11th aspect of the present invention, in the information processing device according to the 8th aspect, it is preferable that the optimal assembly position determining unit is configured to determine the optimal assembly position based on the clearance information.

According to a 12th aspect of the present invention, in the information processing device according to the 11th aspect, it is preferable that the optimal assembly position determining unit is configured to determine the optimal assembly position where a variance of the degree distribution is minimized. According to a 13th aspect of the present invention, in the information processing device according to the 11th aspect, it is preferable that the optimal assembly position determining unit is configured to determine the optimal assembly position where a minimum value of the plurality of distances is the smallest.

According to a 14th aspect of the present invention, in the information processing device according to any one of the 5th to 7th aspect, it is preferable to comprise an optimal assembly position determining unit configured to determine an optimal assembly position between the first assembly part and the second assembly part, wherein: the optimal assembly position determining unit is configured to determine the optimal assembly position where the first clearance amount is minimized.

According to a 15th aspect of the present invention, in the information processing device according to any one of the 1st to 14th aspect, it is preferable to comprise: a relative position information generating unit configured to generate the first relative position information and the second relative position information, assuming that the first member and the second member are assembled together.

According to a 16th aspect of the present invention, in the information processing device according to the 15th aspect, it is preferable that the relative position information generating unit is configured to calculate the first relative position information and the second relative position information based on amounts of deformation of the first member and the second member, assuming that the first member and the second member are assembled together.

According to a 17th aspect of the present invention, a program causing a computer to execute a calculation process that, assuming that a first member, provided with a first clearance adjustment target part and a first assembly part, and a second member, provided with a second clearance adjustment target part and a second assembly part, are assembled together by abutting the first assembly part the second assembly part each other, calculates clearance information between the first clearance adjustment target part and the second clearance adjustment target part, wherein: the program causes the computer to execute the calculation process that calculates the clearance information based on: first shape measurement data of the first assembly part; second shape measurement data of the second assembly part; first relative position information of the first clearance adjustment target part with respect to the first assembly part; and second relative position information of the second clearance adjustment target part with respect to the second assembly part.

According to a 18th aspect of the present invention, a workflow generating device, comprises: a component selecting unit configured to select a thickness of a spacer based on the clearance information calculated by the information processing device according to any one of the 1st to 16th aspects.

### BRIEF DESCRIPTION OF DRAWINGS

FIG. 1 is a schematic diagram of an information processing device of a first embodiment of the present invention.

FIG. 2 is a cross-sectional view of a first member and a second member according to one embodiment of the present invention.

FIG. 3 is a diagram illustrating an assembly part according to the one embodiment of the present invention.

FIG. 4 is a cross-sectional view of the first member and the second member after an assembly according to the one embodiment of the present invention.

FIG. 5 is a cross-sectional view of clearance measurement parts according to the one embodiment of the present invention.

FIG. 6 is a diagram illustrating a method for setting an inter-element distance between the clearance measurement parts according to the one embodiment of the present invention.

FIG. 7 is a diagram illustrating a degree distribution regarding between the clearance measurement parts according to the one embodiment of the present invention.

FIG. 8 is a diagram illustrating a weighted degree distribution according to the one embodiment of the present invention.

FIG. 9 is a flow chart illustrating a flow for selecting a spacer according to the first embodiment of the present invention.

FIG. 10 is a schematic diagram of an information processing device of a second embodiment of the present invention.

FIG. 11 is a diagram for illustrating an assembly position according to the second embodiment of the present invention.

FIG. 12 is a flow chart illustrating a flow for selecting the spacer according to the second embodiment of the present invention.

FIG. 13 is a diagram for illustrating a method for calculating the assembly position after an assembly according to the second embodiment of the present invention.

FIG. 14 is a diagram illustrating an entire configuration of devices used to provide a program product according to the one embodiment of the present invention.

### DESCRIPTION OF EMBODIMENTS

The following describes an information processing device according to one embodiment of the present invention with reference to the drawings as necessary.

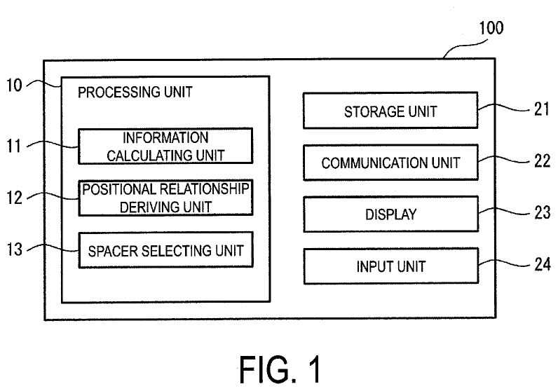

FIG. 1 is a schematic diagram illustrating a functional block of an information processing device 100 of the embodiment. The information processing device 100 includes a processing unit 10, a storage unit 21, a communication unit 22, a display 23, and an input unit 24. The processing unit 10 includes an information calculating unit 11, a positional relationship deriving unit 12, and a spacer selecting unit 13.

The information processing device 100 calculates, assuming that two members (hereinafter each referred to as a first member and a second member) are assembled, information on a clearance between the first member and the second member (hereinafter referred to as clearance information). Here, in the assembly, parts where the first member and the second member are brought into abutment are referred to as a first assembly part and a second assembly part, respectively. In addition, parts of the first member and the second member being a target for the calculation of the clearance information are referred to as a first clearance adjustment target part and a second clearance adjustment target part, respectively.

The processing unit 10 mainly executes various kinds of information processing of the embodiment. Functions illustrated by respective functional blocks in the processing unit 10 are mainly executed by a CPU (not shown in the figures). The CPU executes various analyses including the calculation of the clearance information based on programs and data stored in the storage unit 21.

The storage unit 21 is composed of a storage device such as a semiconductor memory or a hard disk and stores various kinds of data used in various kinds of information processing by the processing unit 10. The data includes programs for execution of various kinds of the information processing including the calculation of the clearance information; and shape data of the first member and the second member. The shape data includes shape measurement data of the first assembly part and the second assembly part (hereinafter referred to as first shape measurement data and second shape measurement data, respectively), and relative position information of the first clearance adjustment target part relative to the first assembly part and of the second clearance adjustment target part relative to the second assembly part (hereinafter referred to as first relative position information and second relative position information, respectively). The shape data are obtained via the communication unit 22 and/or the input unit 24 described later and stored in the storage unit 21.

Hereinafter, when simply referred to as “assembly part”, this means an inclusion of both the first assembly part and the second assembly part. The same applies to “member”, “clearance measurement part”, “shape measurement data”, and “relative position information”.

The communication unit 22 is composed of a terminal configured to communicate via a network such as the Internet. The communication unit 22 connects to an external database or the like as necessary to obtain specification data of the member, receives information necessary for a process executed by the processing unit 10, and transmits the process result by the processing unit 10. The display 23 is composed of a display monitor such as a liquid crystal monitor (not shown in the figures) and displays the process results and the like to a user.

The input unit 24 is composed of an input device, such as a keyboard and/or a touch panel, and serves as an interface for receiving information necessary for a process executed by the processing unit 10, such as the shape measurement data and the relative position information, from the user. The input unit 24 can be configured including the display monitor described above or the like for presenting an information input screen to the user. In this way, each functional block of the information processing device 100 does not inhibit sharing a physical body.

The following describes the information processing executed by the processing unit 10 in the information processing device 100 of the embodiment in detail.

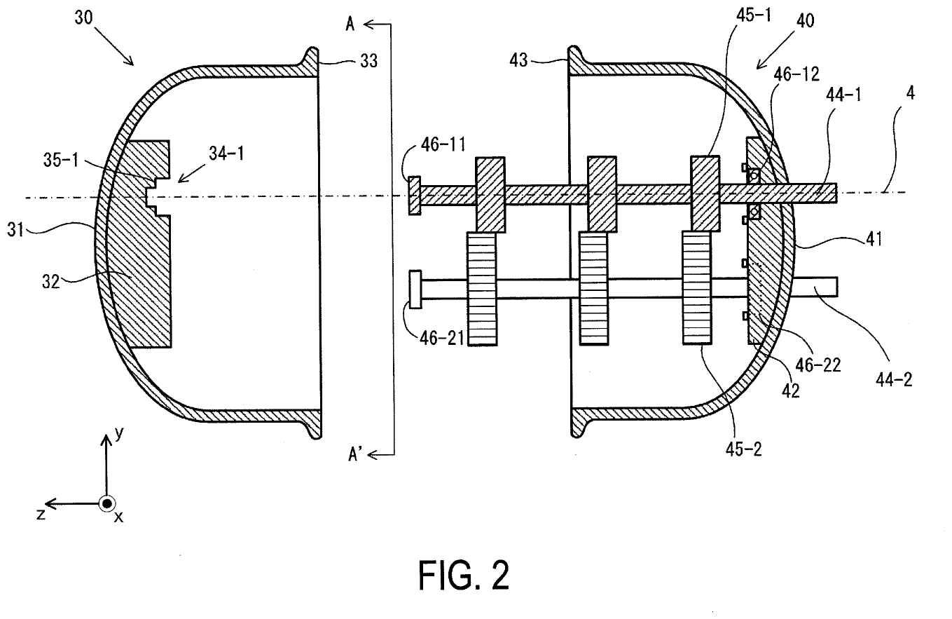

FIG. 2 is a diagram (a cross-sectional view including a central axis 4 of a drive shaft 44-1 described later) illustrating a first member 30 and a second member 40 to be analyzed by the information processing device 100 of the embodiment as an example. The first member 30 includes a first member side housing 31 and a base 32. The first member side housing 31 includes a first assembly part 33. The base 32 includes a fitting hole 34-1 into which a drive side bearing 46-11 assembled to the drive shaft 44-1 of the second member 40 described later is fitted. The fitting hole 34-1 includes a raised part 35-1. The second member 40 includes a second member side housing 41, a support table 42, the drive shaft 44-1 and a driven shaft 44-2. The drive shaft 44-1 is assembled to the support table 42 via a drive side bearing 46-12. The second member side housing 41 includes a second assembly part 43. The drive shaft 44-1 includes a drive gear 45-1 and the drive side bearings 46-11 and 46-12. The driven shaft 44-2 includes a driven gear 45-2 and driven side bearings 46-21 and 46-22. The driven shaft 44-2 is assembled to the support table 42 via the driven side bearing 46-22. The drive gear 45-1 is engaged with a driven gear 45-2 and shifts and transmits rotation of the drive shaft 44-1 about the central axis 4 to the driven shaft 44-2.

As illustrated in coordinate axes of FIG. 2, for ease of description, a direction parallel to the drive shaft 44-1 and the driven shaft 44-2 is defined as a Z-axis direction and a direction in which the second member 40 makes relative movement for assembly is defined as a Z-axis+side. Furthermore, a direction along the paper surface orthogonal to the Z-axis is defined as a Y-axis direction, and the upper side of the paper surface is defined as a Y-axis+side. A direction orthogonal to the Z-axis and the Y-axis is defined as an X-axis direction, and the front side of the paper surface is defined as an X-axis+side. Some subsequent figures illustrate the coordinate axes for understanding of an orientation of each diagram based on the coordinate axes of FIG. 2.

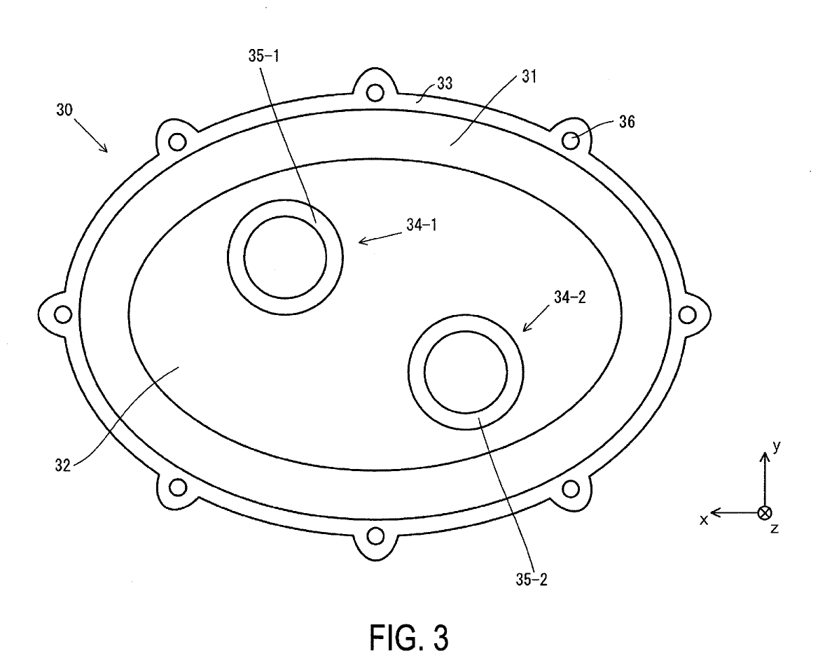

FIG. 3 is a diagram of the first member 30 viewed from an A-A′ plane (FIG. 2) parallel to the X-Y plane. The first member side housing 31 of the first member 30 includes a band-shaped first assembly part 33 in its outer frame and a plurality of screw holes 36 for fastening together the first member 30 and the second member 40 with screws. The base 32 includes the drive shaft fitting hole 34-1 and a driven shaft fitting hole 34-2 that correspond to the drive side bearing 46-11 and the driven side bearing 46-21, respectively. Respective bottom surfaces of the drive shaft fitting hole 34-1 and the driven shaft fitting hole 34-2 are parallel to the A-A′ plane and are provided with annular raised parts such that an end surface of the drive shaft 44-1 on the Z-axis+side does not contact the base 32. The annular raised part 35-1 in the drive shaft fitting hole 34-1 is configured to face an outer ring of the drive side bearing 46-11. An annular raised part 35-2 in the driven shaft fitting hole 34-2 is configured to face an outer ring of the driven side bearing 46-21.

In the following explanation of the calculation of the clearance information, only the clearance information on the drive side will be described. The calculation of the clearance information on the driven side is the same as that of the drive side, and thus the description is omitted, but the scope of the present invention also includes the calculation of the clearance information on the driven side.

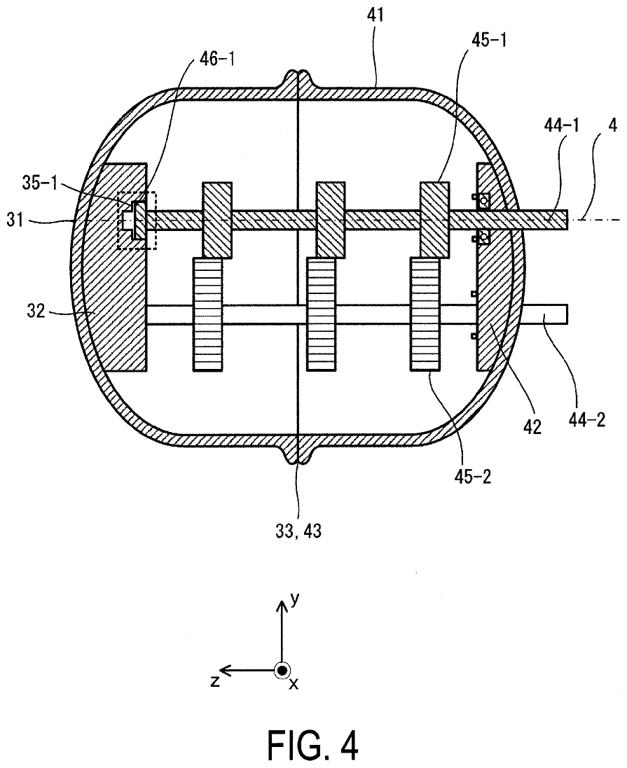

FIG. 4 is a cross-sectional view of the first member 30 and the second member 40 after the assembly, including the central axis 4 of the drive shaft 44-1. The first assembly part 33 is brought into abutment with the second assembly part 43 to fix together the first member side housing 31 and the second member side housing 41. As described above, the drive side bearing 46-11 of the drive shaft 44-1 is fitted into the fitting hole 34-1 provided in the base 32.

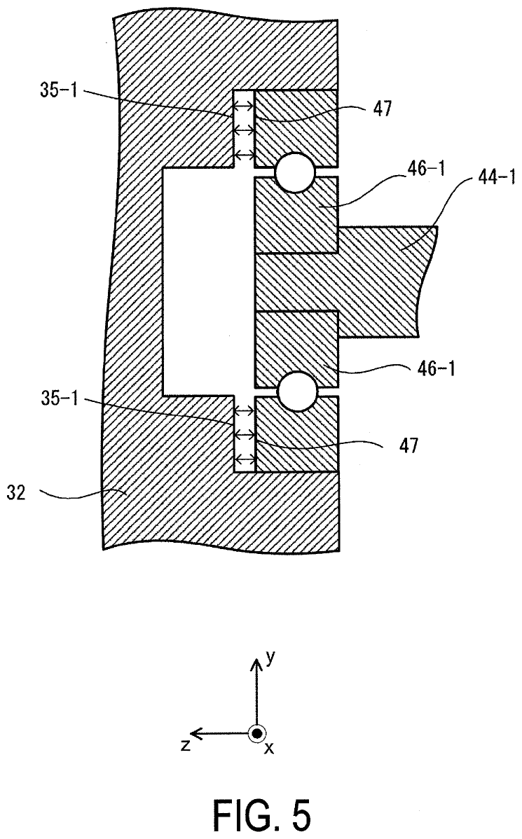

FIG. 5 is an enlarged view of the dotted line portion of FIG. 4 to describe the clearance measurement part. The annular raised part 35-1 in the fitting hole 34-1 of the base 32 is opposite an outer ring side surface 47 of the drive side bearing 46-11 that is a rolling bearing fixed to the drive shaft 44-1 by interference fit. Setting the clearance (indicated by the arrows in the diagram) between the annular raised part 35-1 and the outer ring side surface 47 to be an appropriate value is important to stably achieve the rotational transmission from the drive shaft 44-1 to the driven shaft 44-2. To do so, the first member 30 and the second member 40 are designed such that the clearance between the raised part 35-1 and the outer ring side surface 47 becomes relatively large, and a spacer having an appropriate thickness is disposed in this clearance. As a result, the outer ring side surface 47 is pressed against the raised part 35-1 with an appropriate force. Conventionally, to determine the spacer having the appropriate thickness, the first member 30 and the second member 40 were once assembled together (temporarily assembled), and operations of the drive shaft 44-1 and the driven shaft 44-2 were repeatedly checked every time the thickness of the spacer was changed to select the appropriate thickness of the spacer. Therefore, in a case where the information on the clearance between the raised part 35-1 and the outer ring side surface 47 is calculated before the actual assembly, a suitable spacer can be selected to complete the assembly without repeating the temporary assembly as described above.

Note that in the embodiment, the annular raised part 35-1 in the fitting hole 34-1 of the first member 30 and the outer ring side surface 47 of the drive side bearing 46-11 are set as the clearance measurement parts. However, a combination of different surfaces mutually opposite between the first member 30 and the second member 40 may also be employed.

Calculation of Clearance Information

The processing unit 10 reads the shape measurement data (first shape measurement data) of the first assembly part 33 and shape data of the surface of the annular raised part 35-1 in the fitting hole 34 of the first member 30 stored in the storage unit 21. The processing unit 10 also reads the shape measurement data (second shape measurement data) of the second assembly part 43 and shape data of the outer ring side surface 47 of the drive side bearing 46-11 of the second member 40 stored in the storage unit 21. Furthermore, the processing unit 10 reads the relative position information (first relative position information) between the first assembly part 33 and the raised part 35-1 and the relative position information (second relative position information) between the second assembly part 43 and the outer ring side surface 47 of the drive side bearing 46-1, which are nominal data (nominal reference data) stored in the storage unit 21.

While the method for measuring the data related to these shapes is not particularly limited, the data may be obtained by, for example, a sensor configured to measure a three-dimensional shape of a part to be measured. Specific examples include a light cut sensor using a triangulation method and an X-ray CT device. Such sensors are contactless shape measurement sensors and therefore are also effective in measuring a shape at a location difficult to be contacted, compared with a contact-type sensor. These shape measuring means may be combined with the embodiment so that the shape measurement data (first shape measurement data) of the first assembly part 33 and the shape data of the surface of the annular raised part 35-1 in the fitting hole 34 of the first member 30 may be obtained from the shape measuring means.

Hereinafter, to avoid redundancy, the annular raised part 35-1 in the fitting hole 34 of the first member 30 is referred to as a first clearance adjustment target part 35-1, and the outer ring side surface 47 of the drive side bearing 46-1 of the second member 40 is referred to as a second clearance adjustment target part 47. Note that a technical significance of the term of the clearance measurement part is not to be limited.

The positional relationship deriving unit 12 in the processing unit 10 calculates the respective three-dimensional positions of the first clearance adjustment target part 35-1 and the second clearance adjustment target part 47 after the first member 30 and the second member 40 are assembled together on the basis of the shape measurement data and the relative position information as the nominal data. Specifically, the processing unit 10 obtains the calculation result by performing the following step. The processing unit 10 first calculates the relative positional relationship between the first member 30 and the second member 40 at the assembly parts 33 and 43 from the shape measurement data and the relative position information.

The first member 30 and the second member 40 in the embodiment include screw holes in the first assembly part 33 and the second assembly part 43 to ensure fastening with screws. Screw fastening positions of these screw holes are identified by the assembly positional relationship deriving unit 12 in the processing unit 10 using the shape measurement data and/or design information of the first member 30 and the second member 40. Furthermore, the positional relationship deriving unit 12 obtains assembly work instruction information such as a fastening sequence and a fastening force, in addition to the shape measurement data, the relative position information and the information on the fastening positions of the screws, and calculates the position information and the shapes of the assembly parts after the assembly and the relative position information after the assembly from the obtained information. For example, from the fastening forces of the screws and the Young's modulus of a material of each member, an amount of elastic deformation of each member can be calculated, and the calculated amount can be taken into account when calculating the position information and the shapes of the assembly parts 33 and 43 and when calculating the relative position information. For example, the use of a Computer added engineering (CAE) technique such as structural analysis software using a finite element method or the like allows calculating the above information. Thus, the positional relationship deriving unit 12 preferably has a volume model forming function that forms a volume model from the shape data, a finite element model generating function that replaces the volume model with a finite element model, a finite element analyzing function that executes relative finite element analysis based on the assembly work instruction information obtained by the positional relationship deriving unit 12 using the generated finite element model, and a function that calculates the shapes of the first member 30 and the second member 40 after the assembly from the finite element analysis result.

Incidentally, in a case where, for example, the assembly is performed through a plurality of steps such that the plurality of screws are sequentially fastened in a certain sequence, the positional relationship deriving unit 12 can calculate amounts of deformation of the assembly parts 33 and 43 and/or the clearance measurement parts 35-1 and 47 in each step and calculate changes in the position information and the shapes of the assembly parts and in the relative position information between before and after the assembly. The information calculating unit 11 can three-dimensionally analyze the clearance measurement parts from the calculated information of the assembly parts 33 and 43 and relative position information after the assembly and calculate the three-dimensional positions of the clearance measurement parts 35-1 and 47.

As described above, while the embodiment treats the assembly parts 33 and 43 and the clearance measurement parts 35-1 and 47 as the surfaces, the shape measurement data may include a parameter such as the Young's modulus so as to take into consideration the deformations of the assembly parts 33 and 43 and of the clearance measurement parts 35-1 and 47.

The assembly parts and the clearance measurement parts are not only defined as planes but may be defined as three-dimensional regions.

The positional relationship deriving unit 12 preferably calculates changes in the positions of the assembly parts 33 and 43 after the assembly in a direction perpendicular to these surfaces, that is, an axial direction of the drive shaft 44-1. This is because even when an angle of the surface of the assembly part 33 or 43 changes slightly, the position of the second clearance adjustment target part 47, which is on the distal end of the drive shaft 44-1, changes greatly.

The information calculating unit 11 analyzes information on distances between the first clearance adjustment target part 35-1 and the second clearance adjustment target part 47 from the three-dimensional positions of the first clearance adjustment target part 35-1 and the second clearance adjustment target part 47 obtained from the positional relationship deriving unit 12.

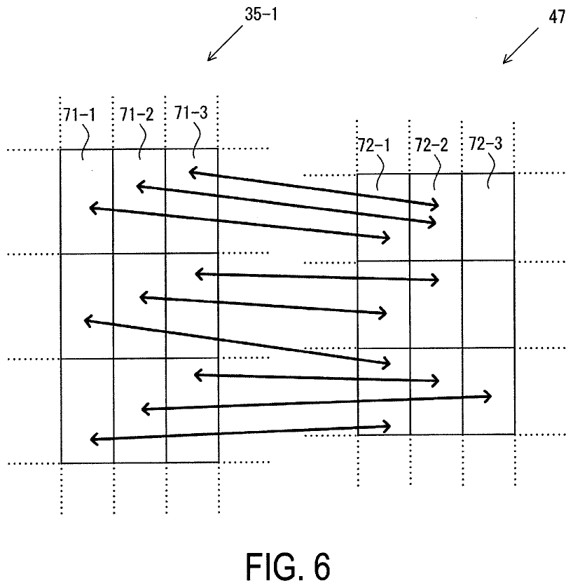

FIG. 6 is a conceptual diagram for describing a plurality of distances defined between the clearance adjustment target parts. The information calculating unit 11 divides the first clearance adjustment target part 35-1 into a plurality of planar elements 71. The information calculating unit 11 divides the second clearance adjustment target part 47 into a plurality of planar elements 72. FIG. 6 expresses the respective planar elements 71 (such as 71-1, 71-2, and 71-3) and the respective planar elements 72 (such as 72-1, 72-2, and 72-3) in a manner transferred on the same plane. Each planar element 71 is associated with a distance to any one of the planar elements 72 at the closest distance (hereinafter referred to as an inter-element distance) of the second clearance adjustment target part 47. In the example in the diagram, the planar element 71-1 is combined with the planar element 72-1, the planar element 71-2 is combined with the planar element 72-2, and the planar element 71-3 is combined with the planar element 72-2. That is, the planar element 72-2 is the planar element closest to both of the planar element 71-2 and the planar element 71-3. In this way, in terms of the definition of the inter-element distance, a plurality of the planar elements 71 of the first clearance adjustment target part 35-1 may be combined with one planar element 72 of the second clearance adjustment target part 47.

Note that as the inter-element distance, a distance between one planar element 71 of the first clearance adjustment target part 35-1 and a planar element 72 of the second clearance adjustment target part 47 at a position opposite the one planar element 71 along the assembly direction may be assigned. The distance between each planar element 72 of the second clearance adjustment target part 47 and the planar element 71 of the first clearance adjustment target part 35-1 at the closest distance may be defined as the inter-element distance.

While a method for dividing into the planar elements 71 and 72 is not particularly limited, it is desirable for the calculation of the exact distance that a width taken in any direction of the one planar element 71 or 72 is sufficiently small compared with the inter-element distance.

The information calculating unit 11 plots a distribution of a total of areas of the planar elements 71 corresponding to a range of values of the inter-element distances in a constant width based on the planar elements 71 and the data of the inter-element distances defined in the respective planar elements 71. For example, when the sum of the areas of the plurality of planar elements 71 with the values of the inter-element distances of 3.0 mm or more and less than 3.1 mm is 2.0 mm², this total of the areas of 2.0 mm² is plotted as the value on the vertical axis relative to a value on the horizontal axis of 3.05 mm that is a representative value in a range of the inter-element distances of 3.0 mm or more and less than 3.1 mm. A manner of selecting the representative value in a range of the inter-element distances is not particularly limited as long as the analysis results are not significantly affected.

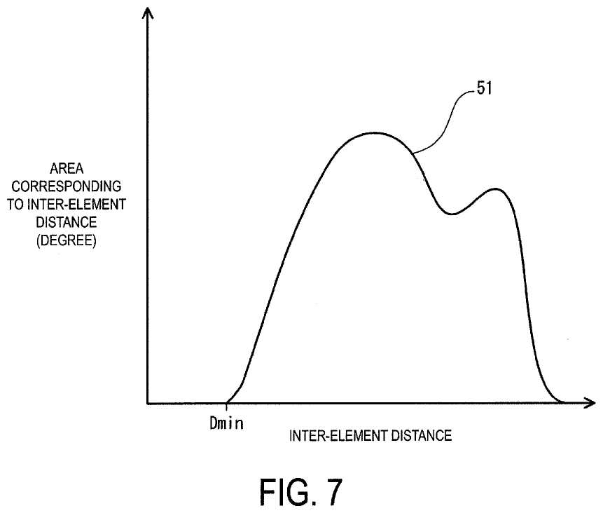

FIG. 7 is a diagram illustrating an example of the distribution of the values of the areas relative to the obtained inter-element distances. The horizontal axis indicates the inter-element distance, and the vertical axis indicates the sum of the areas of the corresponding planar elements 71 of the first clearance adjustment target part 35-1. While, as explained above, in calculating the sum of the areas corresponding to the inter-element distance, the values of the inter-element distances are separated in units of a constant width, FIG. 7 illustrates a smooth distribution having a sufficiently small constant width. Since the areas corresponding to the respective inter-element distances also correspond to frequencies (degrees) of the respective inter-element distances between the first clearance adjustment target part 35-1 and the second clearance adjustment target part 47, the following designates the distribution of the total of the areas of the planar elements 71 of the first clearance adjustment target part 35-1 corresponding to the respective inter-element distances relative to the inter-element distances as a clearance degree (frequency) distribution 51. Note that the total of the areas may be calculated from the areas of the planar elements 72 of the second clearance adjustment target part 47.

The clearance degree distribution 51 indicates the minimum value of the inter-element distance by Dmin in the figure. The minimum value Dmin of the inter-element distance is the smallest value of the clearance between the clearance adjustment target parts in terms of the definition of the inter-element distance.

The information calculating unit 11 can weight the obtained clearance degree distribution 51 for analysis.

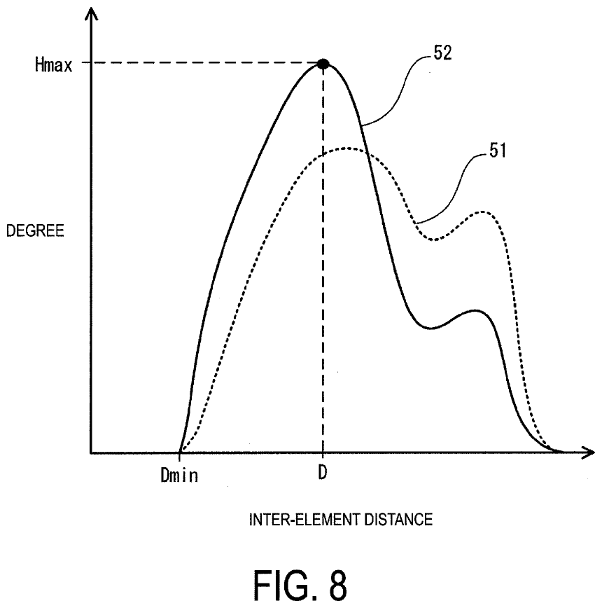

FIG. 8 is an example of a weighted degree distribution 52 obtained by weighting the clearance degree distribution 51. When comparing two points present in the degree distribution 51 having different values of the inter-element distances, the information calculating unit 11 can execute weighting such that a point with a smaller inter-element distance among the two points is multiplied by a larger weighting coefficient. Preferably, the smaller the inter-element distance is, the larger weighting coefficient can be multiplied. In such a case, as illustrated in FIG. 8, the weighted distribution 52 exhibits a distribution in which the clearance degree distribution 51 before the weighting is increased and compressed on the smaller inter-element distance side.

When the first member 30 and the second member 40 are assembled together, for example, a problem that the second clearance adjustment target part 47 is pressed strongly against the first clearance adjustment target part 35-1 more than necessary may arise on the small clearance side in the clearance degree distribution. For example, when the outer ring side surface 47 as the second clearance adjustment target part 47 of the drive side bearing 46-11 is pressed strongly against the raised part 35-1 more than necessary, the rotation of the drive shaft 45-1 may be hindered. Therefore, the analysis is preferably executed by weighting in a range where the clearance between the clearance adjustment target parts is comparably small.

In addition, the information calculating unit 11 can define a certain threshold value for the inter-element distance and set a higher weighting coefficient to inter-element distances equal to or less than this threshold value than a weighting coefficient to inter-element distances exceeding this threshold value. Furthermore, a point corresponding to the minimum value Dmin of the inter-element distance or one point selected from a predetermined range determined by the minimum value Dmin of the inter-element distance may be multiplied by the largest weighting coefficient. A magnitude of the predetermined value may be set so as to be sufficient to achieve a substantially same effect as providing the maximum weighting coefficient to the minimum value Dmin of the inter-element distance.

The information calculating unit 11 calculates an optimal representative value of the clearances between the clearance adjustment target parts from the obtained weighted degree distribution 52. The information calculating unit 11 selects a value of the inter-element distance corresponding to one local maximum value or the maximum value Hmax in the weighted degree distribution 52 as the representative value D of the clearances. Alternatively, the information calculating unit 11 may select a value of the inter-element distance corresponding to any of the weighted degrees of 95% or more of the local maximum or the maximum value Hmax as a representative value D of the clearances. The information calculating unit 11 may select a value of the inter-element distance corresponding to any of the weighted degrees of 90%, 85%, 80%, or 75% or more of the local maximum or the maximum value Hmax as a representative value D of the clearances. Furthermore, the information calculating unit 11 may select, as the local maximum value, a value with the smallest inter-element distance among a plurality of local maximum values in the weighted degree distribution 52.

Note that the information calculating unit 11 may select any percent point, such as the center value in the weighted degree distribution 52, as a representative value D of the clearances. The information calculating unit 11 may select a representative value D of the clearances based on the clearance degree distribution 51 before the weighting in the same manner as in the case of the weighted degree distribution 52.

The selecting unit 13 selects a spacer having an appropriate thickness to be disposed and provided between the first clearance adjustment target part 35-1 and the second clearance adjustment target part 47 based on the representative value D of the clearances calculated by the information calculating unit 11. The selecting unit 13 preferably selects the spacer having a thickness value closest to the representative value D of the clearances among available spacers. The spacer described here is a spacer having a surface abutting on the first clearance adjustment target part 35-1 and a surface abutting on the second clearance adjustment target part 47 are parallel or substantially parallel and having a shape insertable into the fitting hole 34.

Note that in a case where it is not preferable for the spacer to contact the first clearance adjustment target part 35-1 and the second clearance adjustment target part 47 and where the clearance between both is desired to be as small as possible, the selecting unit 13 preferably selects a spacer having the maximum thickness among spacers having a thickness smaller than the minimum value Dmin of the inter-element distance.

Note if it is possible to prepare a spacer having the surface abutting on the first clearance adjustment target part 35-1 and the surface abutting on the second clearance adjustment target part 47 not parallel to one another (a spacer having varying thicknesses depending on locations), the selection method is not to be limited the one described above, and a spacer whose thickness distribution is similar to a thickness distribution regarding the clearance between the clearance adjustment target parts may be selected.

While in the above-described description, the information calculating unit 11 calculates the representative value D of the clearance corresponding to the thickness of the spacer, a parameter is not to be limited as long as it is defined in between the clearance adjustment target parts. The information calculating unit 11 needs not to use an index of a thickness of the spacer but can be configured to calculate various amounts, not limited to a specific form such as a scalar, a vector, and a matrix, as indices characterizing narrowness between the clearance adjustment target parts.

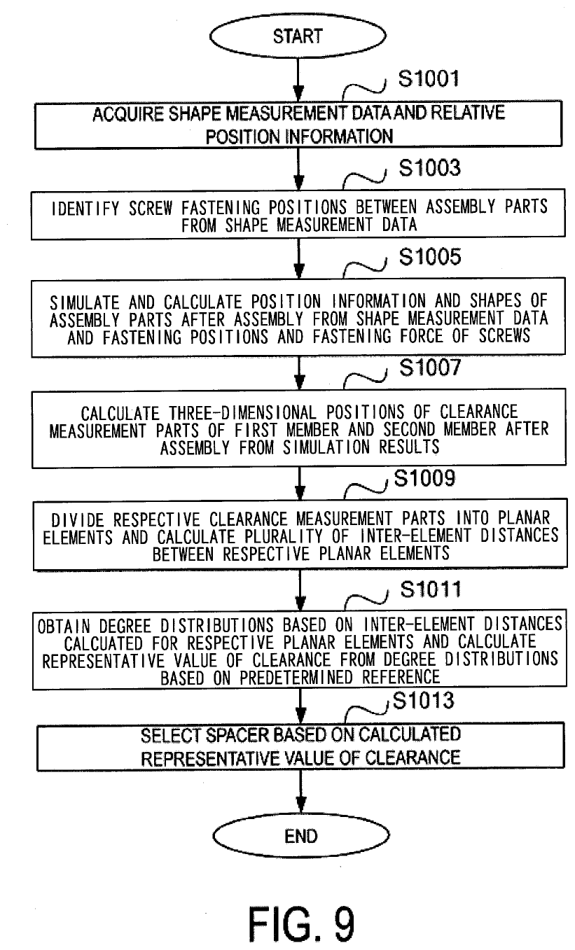

FIG. 9 is a flow chart depicting a flow for the information processing device 100 to select an appropriate thickness of the spacer disposed between the first clearance adjustment target part 35-1 and the second clearance adjustment target part 47.

In Step S1001, the processing unit 10 obtains the shape measurement data of the first member 30 and the second member 40, and the relative position information after fastening together the first member 30 and the second member 40 as the nominal data, and then advances the process to Step S1003. In Step S1003, the positional relationship deriving unit 12 in the processing unit 10 identifies screw fastening positions 36 and 48 between the assembly parts from the obtained shape measurement data, and then advances the process to Step S1005.

In Step S1005, the positional relationship deriving unit 12 in the processing unit 10 calculates through simulation the position information and the shapes of the assembly parts 33 and 43 after the assembly from the shape measurement data and the relative position information after the fastening as the nominal data obtained in Step S1001, the fastening positions, the fastening sequence and the fastening force of the screws, and the shape data of the first member 30 and the second member 40, and then advances the process to Step S1007. In Step S1007, the positional relationship deriving unit 12 in the processing unit 10 calculates the three-dimensional positions of the first clearance adjustment unit target part 35-1 and the second clearance adjustment target part 47 of the first member 30 and the second member 40 after the assembly from the simulation results, and then advances the process to Step S1009.

In Step S1009, the information calculating unit 11 divides the respective clearance adjustment target parts 35-1 and 47 into planar elements, calculates a plurality of inter-element distances between the respective planar elements, and advances the process to Step S1011. In Step S1011, the information calculating unit 11 obtains a degree (or frequency) distribution such as a clearance degree distribution 51 and/or a weighted degree distribution 52 based on the inter-element distances calculated for the respective planar elements, and calculates a representative value D of the clearance from these degree distributions based on a predetermined reference. After the representative value D of the clearance is calculated, the process proceeds to Step S1013.

In Step S1013, the selecting unit 13 selects an appropriate spacer to be disposed between the clearance measurement parts based on the representative value D of the clearance calculated by the information calculating unit 11. After selecting the spacer, the process is terminated.

According to the first embodiment described above, the following operational effects are obtained.

(1) The information processing device 100 of the embodiment includes the calculating unit. The calculating unit is configured to calculate the representative value D of the clearance based on: the first shape measurement data of the first assembly part 33; the second shape measurement data of the second assembly part 43; the first relative position information of the first clearance adjustment target part 35-1 with respect to the first assembly part 33; and the second relative position information of the second clearance adjustment target part 47 with respect to the second assembly part 43 for calculating the clearance information between the first clearance adjustment target part 35-1 and the second clearance adjustment target part 47, in a case where the first member 30 including the first clearance adjustment target part 35-1 and the first assembly part 33, and the second member 40 including the second clearance adjustment target part 47 and the second assembly part 43 are assembled together by the first assembly part 33 abutting on the second assembly part 43 or are assumed to be assembled as such. As a result, an effective clearance size can be obtained before assembly, and an appropriate spacer to be disposed in this clearance can be selected.
(2) In the information processing device 100 of the embodiment, the first clearance adjustment target part 35-1 and the second clearance adjustment target part 47 have respective surfaces opposite one another. The clearance information calculated by the information calculating unit 11 includes a clearance degree distribution 51 based on a plurality of inter-element distances between the first clearance adjustment target part 35-1 and the second clearance adjustment target part 47. In this way, the statistical processing of the clearance degree distribution 51 allows quantitatively analyzing three-dimensional information of the clearance between the first clearance adjustment target part 35-1 and the second clearance adjustment target part 47. This three-dimensional information of the clearance includes various kinds of information between the members, such as the value of the minimum clearance between the members, an inter-element distance for each region of the members, or the distribution information of their values. However, the invention may be configured to designate one parameter.
(3) In the information processing device 100 of the embodiment, a plurality of inter-element distances between the clearance measurement parts 35-1 and 47 are a plurality of values between a plurality of planar elements 71 of the first clearance adjustment target part 35-1 and a plurality of planar elements 72 of the second clearance adjustment target part 47 corresponding to the planar elements. This allows quantitatively analyzing the three-dimensional information of the clearance between the first clearance adjustment target part 35-1 and the second clearance adjustment target part 47.
(4) In the information processing device 100 of the embodiment, the clearance degree distribution 51 is, with respect to the inter-element distances between the planar elements 71 and the planar elements 72, the distribution of the values based on the sum of the areas of the planar elements 71 corresponding to the inter-element distances or the distribution of the values based on the sum of the areas of the planar elements 72 corresponding to the inter-element distances. This allows the quantitative analysis as to how frequently and to what extent local varying intervals are distributed in the clearance between the first clearance adjustment target part 35-1 and the second clearance adjustment target part 47.
(5) In the information processing device 100 of the embodiment, the clearance information calculated by the information calculating unit 11 includes the representative value D of the clearance calculated based on the clearance degree distribution 51. As a result, an appropriate thickness of the spacer to be disposed in the clearance between the first clearance adjustment target part 35-1 and the second clearance adjustment target part 47 can be obtained.
(6) In the information processing device 100 of the embodiment, among the distances on the horizontal axis in the weighted degree distribution 52, the information calculating unit 11 is configured to generate the weighted degree distribution 52 by multiplying a degree on the vertical axis corresponding to a first inter-element distance by the first weighting coefficient; and multiplying a degree corresponding to a second inter-element distance larger than the first inter-element distance by a second weighting coefficient smaller than the first weighting coefficient. This allows weighting the point where the inter-element distance is small and the importance is considered to be high, thereby ensuring calculating the more effective clearance information.
(7) In the information processing device 100 of the embodiment, the information calculating unit 11 is configured to calculate a predefined distance determined based on the local maximum value in the weighted degree distribution 52 as the representative value D of the clearance and, with the presence of a plurality of the local maximum values, calculate any of a plurality of the predefined distances determined based on the plurality of the local maximum values as the representative value D of the clearance. This allows extracting the representative value D of the clearance useful for the spacer selection from the weighted degree distribution 52.
(8) The information processing device 100 of the embodiment includes the positional relationship deriving unit 12 configured to generate the first relative position information and the second relative position information when assembly of the first member 30 and the second member 40 is assumed. As a result, the clearance information can be accurately calculated by reflecting changes in the first assembly part 33 and the first clearance adjustment target part 35-1 between before and after the assembly.
(9) In the information processing device 100 of the embodiment, the positional relationship deriving unit 12 is configured to calculate the first relative position information and the second relative position information based on amounts of deformation of the first member 30 and the second member 40 when it is assumed that the first member 30 and the second member 40 are assembled together. As a result, the changes between before and after the assembly takes into consideration the amount of deformation of each member, thereby ensuring further accurate calculation of the clearance information.
(10) The information processing device 100 of the embodiment includes the spacer selecting unit 13. The spacer selecting unit 13 is configured to select a thickness of the spacer based on the clearance information calculated by the information calculating unit 11, and thus the information processing device 100 can be preferably used as a workflow generating device. Accordingly, an appropriate spacer to be disposed in the clearance is selectable before the assembly, thereby ensuring generating a smooth workflow.

### Second Embodiment

While an information processing device 200 according to the second embodiment has the same configuration as the information processing device 200 according to the first embodiment, this information processing device 200 differs from the device according to the first embodiment in that it determines an optimal assembly position (described in detail below) through evaluation with the clearance information. Reference numerals same as those of the first embodiment are used for the components same as those of the first embodiment, and therefore explanation on such components may be omitted as necessary. The members to be measured have the same configurations as the first member 30 and the second member 40 of the first embodiment unless otherwise stated and the reference numerals same as those in the first embodiment are used. Accordingly, explanations thereof may be omitted if necessary.

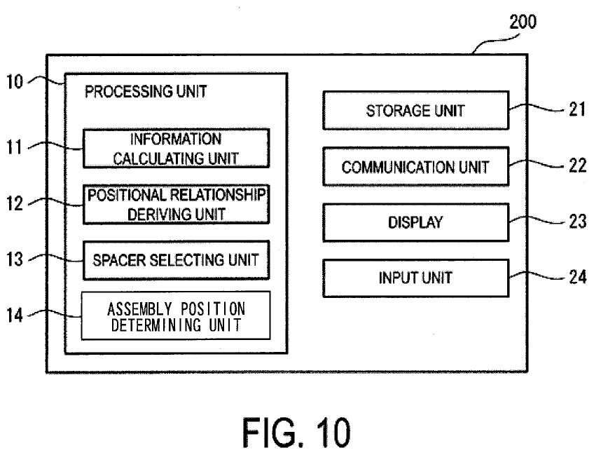

FIG. 10 is a diagram illustrating a functional block of the information processing device 200 of the second embodiment. While the configuration of the functional block of the information processing device 200 is substantially the same as the configuration of the functional block (FIG. 1) of the information processing device 100 of the first embodiment, it is different from the first embodiment in that the processing unit 10 further includes an assembly position determining unit 14 that determines an optimal assembly position.

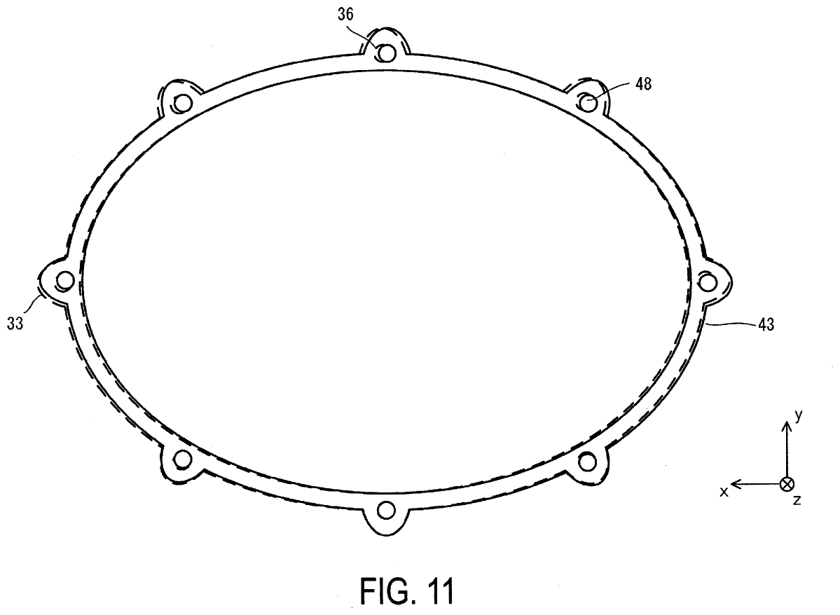

Determination of Assembly Position FIG. 11 is a diagram schematically illustrating the first assembly part 33 (dashed line) and the second assembly part 43 (solid line) to describe an assembly position. The first assembly part 33 and the second assembly part 43 have a degree of freedom in which the relative position is changeable by parallel motion and/or rotation in the X-Y plane when assembling the both members together, depending on the clearance between the screws to assemble together the first member 30 and the second member 40 and the screw holes 36 (hereinafter, a clearance with the fastening member). The position at the assembly within the degree of freedom is referred to as an assembly position in this description.

Note that it has been described above that the assembly position is changed in the range of slight deviation, however, as long as the configuration in which the assembly position can be evaluated based on the clearance information or the like is employed, the deviation may be a larger deviation involving a design change.

The positional relationship deriving unit 12 identifies the relative position between the first member 30 and the second member 40, that is, the positions of both when fastening with the screws on the basis of the shape measurement data and the relative position information. Additionally, on the basis of the screws used for fastening of the members, the positional relationship deriving unit 12 calculates nominal relative position information of the assembly position of the second member 40 with respect to the first member 30 and an allowable range (a range of the degree of freedom of the assembly position of the second member 40 with respect to the first member 30) in any direction using the nominal relative position information as the center. The information calculating unit 11 assumes a plurality of assembly positions from the range of the degree of freedom of the assembly position of the second member 40 and generates the clearance degree distributions 51 for the respective assembly positions. The positional relationship deriving unit 12 can, for example, select a plurality of pieces of the relative position information at constant intervals from a range of the parallel motion in each direction or from a range of the displacement by the relative rotation of the first member 30 and the second member 40 using the nominal relative position information of the assembly position as the center, and generate the clearance degree distribution 51 for each assembly position corresponding to each piece of the relative position information.

The assembly position determining unit 14 calculates a variance value of the clearance degree distribution 51 for each piece of the relative position information generated by the information calculating unit 11 and determines the assembly position corresponding to the clearance degree distribution 51 having the smallest variance value as the optimal assembly position. This is because a space of the clearance where the clearance degree distribution 51 having a small variance value, that is, having a small variation is obtained can be efficiently filled with one spacer.

Note that the assembly position determining unit 14 may calculate a parameter indicating a variation in the clearance degree distribution 51 other than a variance value and use the calculated parameter for evaluation.

Furthermore, the assembly position determining unit 14 may acquire the minimum values Dmin of the respective inter-element distances of a plurality of clearance degree distributions 51 generated by the information calculating unit 11 and determine the assembly position corresponding to the clearance degree distribution 51 having the smallest minimum value Dmin of the inter-element distance as the optimal assembly position.

The information calculating unit 11 calculates the representative value D of the clearance for the optimal assembly position determined by the assembly position determining unit 14. The spacer selecting unit 13 selects a spacer having a thickness closest to the calculated representative value D of the clearance.

Note that the information calculating unit 11 may calculate the respective representative values D of the clearances from the clearance degree distributions 51 for respective estimated or imaginary assembly positions, and the assembly position determining unit 14 may determine the assembly position where the representative value of the clearance is the smallest. In this case, the information calculating unit 11 outputs the already calculated representative value D of the clearance corresponding to the determined assembly position to the spacer selecting unit 13, and the spacer selecting unit 13 selects a spacer having a thickness closest to the representative value D of the clearance.

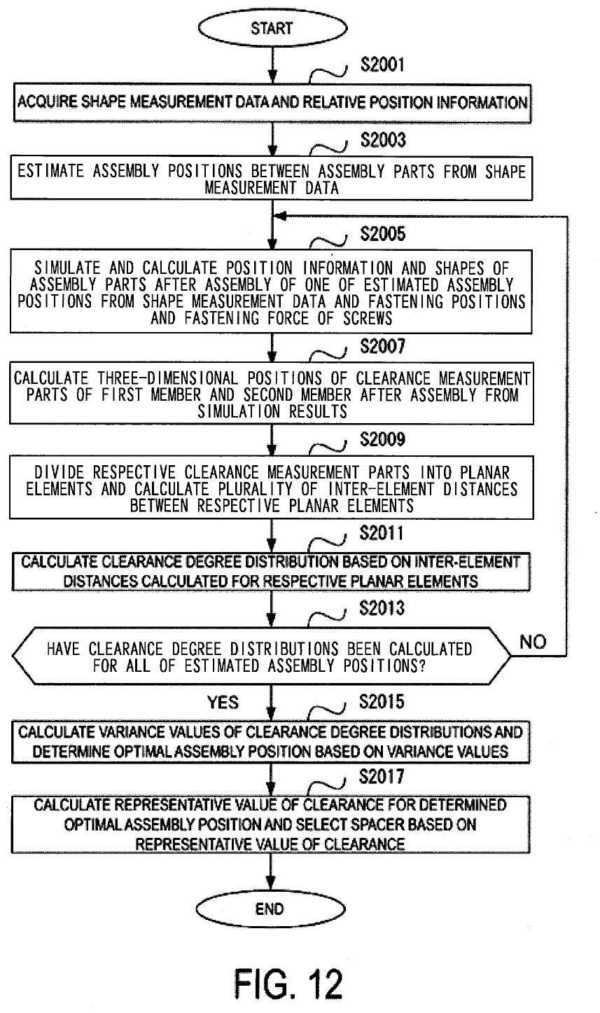

FIG. 12 is a flow chart depicting a flow through which an optimal assembly position of the first member 30 and the second member 40 is determined and a thickness of the spacer at the optimal assembly position is calculated by the information processing device 200.

In Step S2001, the positional relationship deriving unit 12 in the processing unit 10 obtains the shape measurement data of the first member 30 and the second member 40; and the relative position information after fastening together the first member 30 and the second member 40 as the nominal data and advances the process to Step S2003. In Step S2003, the positional relationship deriving unit 12 identifies the screw fastening positions between the assembly parts from the obtained shape measurement data, calculates a range in which the assembly position between the assembly parts may be displaced, estimates a plurality of assembly positions, and advances the process to Step S2005.

In Step S2005, the processing unit 10 simulates and calculates the position information and the shapes of the assembly parts 33 and 43 after the assembly at one of the plurality of assembly positions estimated in Step S2003 from the shape measurement data and the relative position information after the fastening as the nominal data obtained in Step S2001, and the fastening positions, fastening sequence, and fastening force of the screws and then advances the process to Step S2007. In Step S2007, the positional relationship deriving unit 12 calculates the three-dimensional positions of the first clearance adjustment target part 35-1 of the first member 30 and the second clearance adjustment target part 47 of the second member 40 after the assembly at the estimated assembly position from the simulation results and advances the process to Step S2009.

In Step S2009, the information calculating unit 11 divides the respective clearance adjustment target parts 35-1 and 47 into planar elements, calculates a plurality of inter-element distances between the respective planar elements, and advances the process to Step S2011. In Step S2011, the information calculating unit 11 calculates the clearance degree distribution 51 based on the inter-element distances calculated for the respective planar elements. After the clearance degree distribution 51 is calculated, the process proceeds to Step S2013.

In Step S2013, the information calculating unit 11 determines whether the clearance degree distributions 51 have been calculated for all of the estimated assembly positions. If calculation of the clearance degree distributions 51 for all of the estimated assembly positions has been completed, the information calculating unit 11 makes a positive judgement in Step S2013 and advances the process to Step S2015. If an estimated assembly position for which the clearance degree distribution 51 has not yet been calculated is still present, the information calculating unit 11 makes a negative judgement in Step S2013 and returns the process to Step S2005.

In Step S2015, the assembly position determining unit 14 calculates variance values of the clearance degree distributions 51 calculated for the respective estimated assembly positions, determines the estimated assembly position corresponding to the clearance degree distribution 51 having the smallest variance value as the optimal assembly position, and advances the process to Step S2017.

In Step S2017, the information calculating unit 11 calculates the representative value D of the clearance for the optimal assembly position, and the spacer selecting unit 13 selects the spacer based on the calculated representative value D of the clearance. After the spacer is selected, the process is terminated.

According to the second embodiment described above, the following operational effects are obtained in addition to the operational effects obtained by the first embodiment.

(1) The information processing device 200 of the embodiment includes the assembly position determining unit 14 that determines the optimal assembly position between the first assembly part 33 and the second assembly part 43. This makes it possible to generate an efficient assembly step and produce a precise finished product.
(2) In the information processing device 200 of the embodiment, the assembly position determining unit 14 determines the optimal assembly position based on the clearance information. As a result, a finished product having a desired clearance when the first member 30 and the second member 40 are assembled together can be obtained.
(3) In the information processing device 200 of the embodiment, the assembly position determining unit 14 determines the assembly position at which the variance of the clearance degree distribution 51 is the smallest as the optimal assembly position. As a result, a design suitable for disposing the spacer between the first clearance adjustment target part 35-1 and the second clearance adjustment target part 47 can be achieved.
(4) In the information processing device 200 according to the embodiment, the assembly position determining unit 14 determines the assembly position in which the minimum value Dmin of a plurality of inter-element distances is the smallest as the optimal assembly position. As a result, the clearance having the smallest interval at the narrowest part between the first clearance adjustment target part 35-1 and the second clearance adjustment target part 47 can be achieved, and a thin spacer can be disposed in this clearance.
(5) The information processing device 200 of the embodiment determines the assembly position where the representative value of the clearance is the smallest as the optimal assembly position. As a result, the thinnest spacer is selectable as the appropriate spacer disposed between the first clearance adjustment target part 35-1 and the second clearance adjustment target part 47.

Modifications such as the following are also within the scope of the present invention, and it is also possible to combine the modifications with the above-described embodiments.

### Modified Example 1

While in the above-described embodiment, the assembly part determining unit 14 determines the optimal assembly position based on the clearance information, the optimal assembly position may be determined based on the shapes of the assembly parts 33 and 43 after the assembly.

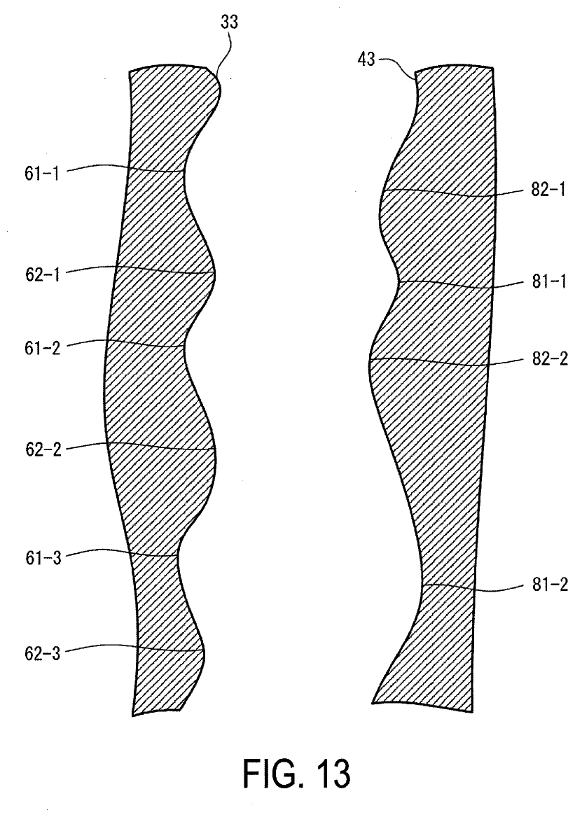

FIG. 13 is a cross-sectional view of the assembly parts before the assembly. The first assembly part 33 and the second assembly part 43 before the assembly are opposite one another. Unevennesses are formed on the assembly part 33 due to a design and/or manufacturing variation. The first assembly part 33 includes first concave portions 61-1, 61-2, and 61-3 and first convex portions 62-1, 62-2, and 62-3. The second assembly part 43 includes second concave portions 81-1 and 81-2 and second convex portions 82-1 and 82-2.

The information calculating unit 11 counts the number at which the first concave portions and the second convex portions abut each other and at which the first convex portions and the second concave portions abut each other at the respective estimated assembly positions. For example, in FIG. 13, the first concave portion 61-1 and the second convex portion 82-1, the first convex portion 62-1 and the second concave portion 81-1, the first concave portion 61-2 and the second convex portion 82-2, the first convex portion 62-2 and the second concave portion 81-2, and the first convex portion 62-3 and the second concave portion 81-2 abut each other. That is, in FIG. 13, there are five pairs of the concave portions and the convex portions. The assembly position determining unit 14 determines the estimated assembly position where the number of pairs of the concave portions and the convex portions is the largest as the optimal assembly position. This allows the assembly at the assembly position where the unevennesses are fitted most.

Note that the information calculating unit 11 can calculate the degree (frequency) distribution and the representative value for the assembly parts 33 and 43 in the same manner as the clearance parts 35-1 and 47 and determine the assembly position where the representative value of the clearance between the assembly parts are the smallest as the optimal assembly position. As a result, the clearance between the assembly parts can be quantitatively analyzed, and the assembly decreasing the clearance between the assembly parts is possible.

### Modified Example 2

A program achieving an information processing function of the information processing device 200 may be recorded in a recording medium that can be read by a computer, and the program regarding the above-described calculation of the clearance information and determination of the assembly position recorded in this recording medium may be read and executed by a computer system. Note that a “computer system” referred to herein includes an OS (operating system) and hardware of a peripheral. Moreover, a “recording medium that can be read by a computer” refers to a portable recording medium such as a flexible disk, a magneto-optical disk, an optical disc, or a memory card; or a storage device such as a hard drive that is built in with the computer system. Moreover, the “recording medium that can be read by a computer” may also include a medium that dynamically holds the program for a short time such as a communication line when sending the program via a network like the Internet or a communication line like a phone line; or a medium that holds the program for a certain amount of time such as a volatile memory inside a computer system serving as a server or a client in this case. Moreover, the program above may be for realizing one portion of the function described above; the function described above may be realized by a combination of this program with a program already recorded in the computer system.

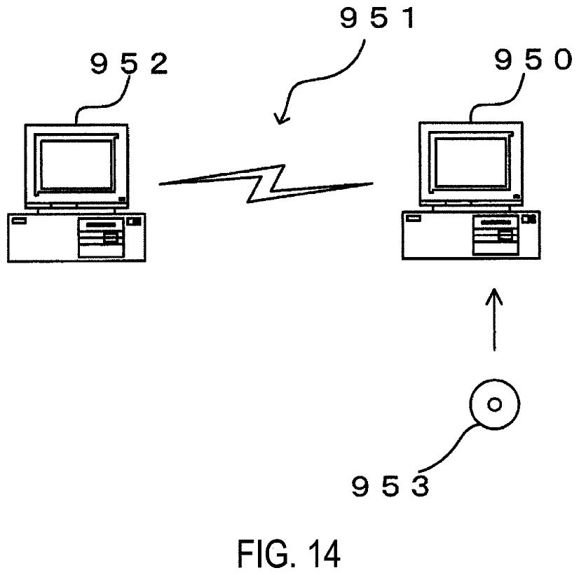

Furthermore, when being applied in a personal computer or the like, the program relating to the control described above can be provided through a recording medium such as a CD-ROM or a data signal such as the Internet. FIG. 14 is a diagram illustrating such a case. A personal computer 950 receives the program provided via a CD-ROM 953. Moreover, the personal computer 950 has a connection function with a communication line 951. A computer 952 is a server computer that provides the program and stores the program in a recording medium such as a hard disk. The communication line 951 is a communication line, such as the Internet or personal-computer communication;

a dedicated communication line; or the like. The computer 952 reads the program using the hard disk and sends the program to the personal computer 950 via the communication line 951. That is, the program is conveyed by a carrier wave as a data signal and sent via the communication line 951. In this manner, the program can be provided as a computer-program product that can be read by a computer in various forms such as a recording medium or a carrier wave.

The present invention is not limited to the contents of the embodiments described above. Other aspects assumed within the scope of the technical concept of the present invention are also included within the scope of the present invention.

### REFERENCE SIGNS LIST

10 Processing unit
11 Information calculating unit
12 Positional relationship deriving unit
13 Spacer selecting unit
14 Assembly position determining unit
21 Storage unit
22 Communication unit
23 Display
24 Input unit
30 First member
33 First assembly part
34-1 Fitting hole
35-1 First clearance adjustment target part
36, 48 Screw hole
40 Second member
43 Second assembly part
44-1 Drive shaft
46-11 Drive side bearing
47 Second clearance adjustment target part
51 Clearance degree distribution
52 Weighted degree distribution
61-1 to 3 First concave portion
62-1 to 3 First convex portion
71-1 to 3, 72-1 to 3 Planar element
81-1, 81-2 Second concave portion
82-1, 82-2 Second convex portion
100, 200 Information processing device
D Representative value of clearance
Dmin Minimum value of inter-element distances
Hmax Local maxima value in degree distribution

1-18. (canceled)

19. An information processing device, comprising:
a position information calculating unit configured to:
calculate first relative position information of a first target part with respect to a first assembly part based on shape measurement data of a first member provided with the first assembly part and the first target part; and
calculate second relative position information of a second target part with respect to a second assembly part based on shape measurement data of a second member provided with the second assembly part and the second target part; and
a distance information calculating unit configured to calculate distance information between the first target part and the second target part, assuming that the first member and the second member are assembled together with the first assemble part and the second assemble part being abutted each other, based on the first relative position information and the second relative position information calculated by the position information calculating unit.

20. The information processing device according to claim 19, wherein:
the distance information calculating unit calculates the distance information between the first target part and the second target part by using shape measurement data of the first assembly part and shape measurement data of the second assembly part.

21. The information processing device according to claim 19, wherein:
the first relative position information includes position information of the first assembly part and the first target part; and
the second relative position information includes position information of the second assembly part and the second target part.

22. The information processing device according to claim 19, wherein:
the first target part and the second target part are surfaces opposite one another; and
the distance information is a plurality of sets of distance information between the first target part and the second target part.

23. The information processing device according to claim 22, wherein:
the plurality of sets of distance information are a plurality of distances for respective elements, each of the plurality of distances being calculated as an inter-element distance between an element of a surface of the first target part and a corresponding element of a surface of the second target part, the surface of the first target part being divided into a plurality of elements and the surface of the second target part being divided into a plurality of elements.

24. The information processing device according to claim 23, wherein:
the distance information calculating unit calculates the number of the elements corresponding to each of the plurality of distances for respective elements; and
the distance information calculating unit calculates a distance between the first target part and the second target part based on the calculated number of elements.

25. The information processing device according to claim 23, wherein:
the distance information calculating unit calculates the number of the elements corresponding to each of the plurality of distances constituting the plurality of sets of distance information by using a coefficient varying depending on the distances; and
the distance information calculating unit calculates a distance between the first target part and the second target part based on the calculated number of elements.

26. The information processing device according to claim 24, wherein:
the distance information calculating unit calculates an inter-element distance at which the calculated number of the elements is the greatest as the distance between the first target part and the second target part.

27. The information processing device according to claim 24, wherein:
the distance information calculating unit calculates, as the distance between the first target part and the second target part, any one of inter-element distances at which the calculated number of the elements is the greatest.

28. The information processing device according to claim 19, comprising:
a position determining unit configured to determine an assembly position of the first assembly part and the second assembly part.

29. The information processing device according to claim 28, wherein:
the position determining unit determines the assembly position of the first assembly part and the second assembly part based on the number of portions at which the first assembly part and the second assembly part abut each other, assuming that the first member and the second member are assembled together with the first assemble part and the second assemble part being abutted each other.

30. The information processing device according to claim 28, wherein:
the position determining unit determines the assembly position of the first assembly part and the second assembly part at which a distance between the first assembly part and the second assembly part is the smallest, assuming that the first member and the second member are assembled together with the first assemble part and the second assemble part being abutted each other.

31. The information processing device according to claim 28, wherein:
the position determining unit determines the assembly position of the first assembly part and the second assembly part based on the distance information between the first target part and the second target part, assuming that the first member and the second member are assembled together with the first assemble part and the second assemble part being abutted each other.

32. The information processing device according to claim 19, wherein:
the distance information calculating unit calculates the distance information between the first target part and the second target part based on amounts of deformation of the first member and the second member, assuming that the first member and the second member are assembled together with the first assemble part and the second assemble part being abutted each other.

33. A computer program product containing a program to be executed by a computer, the program comprising:
calculating first relative position information of a first target part with respect to a first assembly part based on shape measurement data of a first member provided with the first assembly part and the first target part;
calculating second relative position information of a second target part with respect to a second assembly part based on shape measurement data of a second member provided with the second assembly part and the second target part; and
calculating distance information between the first target part and the second target part, assuming that the first member and the second member are assembled together with the first assemble part and the second assemble part being abutted each other, based on the first relative position information and the second relative position information.

34. A workflow generating device, comprising:
a component selecting unit configured to select a thickness of a spacer based on the distance information calculated by the information processing device according to claim 19.

35. A method for producing a finished product, comprising:
determining an assembling position of the first member and the second member based on the assembly position determined by the information processing device according to claim 28; and
producing the finished product by assembling together the first member and the second member based on the determined assembling position.
